(19) United States
(12) Patent Application Publication
(10) Pub. No.: US 2024/0132692 A1
(43) Pub. Date: Apr. 25, 2024

(54) A process for the treatment of waste tyres

(71) Applicant: Politecnico di Milano, Milano MI (IT)

(72) Inventor: Flavio MANENTI, Seriate BG (IT)

(21) Appl. No.: 18/277,281

(22) PCT Filed: Mar. 1, 2022
(86) PCT No.: PCT/IB2022/051799

§ 371 Date: Aug. 15, 2023

(30) Foreign Application Priority Data
Mar. 2, 2021 (IT) 102021000004901

(51) Int. Cl. C08J 11/12; C01B 3/34

(52) U.S. Cl. CPC C08J 11/12; C01B 3/348; C01B 2203/0211; C01B 2203/061; C08J 2319/00

(57) ABSTRACT

Process for chemically treating scrap tyres, comprising the steps of:
a) grinding the tyres and removing the inorganic material;
b) melting the material from step a);
c) devulcanizing the molten material from step b) according to the reaction R1

R1:[—CH₂-]n-S—[—CH₂-]m+H₂=[—CH₂-]ₙ*[—CH₂-]m*H₂S
where m and n indicate non-identical lengths of the macromolecules in terms of carbon atoms and the asterisk indicates the possible presence of at least one ethylene unsaturation, said reaction R1 being possibly associated with the saturation reaction R2 of said possible at least one ethylene unsaturation:

R2:[—CH₂-]n*+[—CH₂-]m*+H 2=[—CH₂-]n+[—CH₂—]m
d) converting the plastics from step c) into products of commercial value. wherein step c):
is carried out in the presence of catalysts based on cobalt oxide or molybdenum oxide possibly supported on alumina;
and comprises a hydrogen sulphide splitting step to create hydrogen and sulphur according to the reaction R3:

R3:H₂S=H₂+1/XSx
and the formed hydrogen is recycled to step c).

### FIELD OF THE INVENTION

The present invention relates to a process and related system for treating tyres and for their chemical conversion into products of high commercial value.

### BACKGROUND ART

One of the main problems for the circular economy is the recovery of plastic waste (plasmix). Plasmix is a complex mixture of polymers of different nature and origin, mainly linear-branched such as Polyethylene (PE) and Polypropylene (PP) and with a reduced content of aromatic polymers such as Polystyrene (PS) and Polyethylene Terephthalate (PET). Otherwise, plasmix can comprise chlorinated plastics (PolyVinylChloride, PVC) or PolyCarbonates (PC) or PolyAmides (for example PolyMethylMetAcrylate, PMMA), as well as other types of plastics and waste of different kinds such as metals, sand or stones. An example of a possible composition is given in the following table

TABLE 1
Composition of plasmix (source COREPLA).

| Polymer | % m/m |
|---|---|
| PE | 40-50 |
| PP | 20-30 |
| PS | 10-20 |
| PET | 5-10 |
| PVC | 2-5 |
| OTHER | 5-15 |

Such plastics are currently recovered mainly by mechanical means, which however reduces their value and limits their use. For these reasons, some chemical processes are also known that involve pyrolysis operations, carried out in the absence of oxygen, or gasification, carried out in the absence of oxygen. However, such chemical recovery technologies have limitations for different areas of application.

In particular, the known processes do not allow tyres to be chemically recovered in a sustainable, economical and efficient manner. The reasons lie in the significant presence of sulphur, used in the tyre vulcanization process. In thermal chemical conversion processes such as pyrolysis and gasification, but also in catalytic processes, sulphur leaks from the vulcanized matrices mainly in the form of H₂S. Therefore, the known treatment technologies firstly have safety problems for the operators and for the environment since H₂S inhibits the nasal sensors already in reduced quantities (of the order of 100 ppm) and in hardly higher quantities it becomes lethal for humans. Secondly, such processes involve management problems of the H₂S that is formed, which is energetically intensive; it is released in the form of gas by reaction with a considerable amount of hydrogen according to the following reaction mechanism:

[—CH₂—]n-S—[—CH₂—]m+H₂=[—CH₂—]n*+[—CH₂—]m*+H₂S
where m and n indicate non-identical lengths of the macromolecules in terms of carbon atoms and the asterisk indicates a possible unsaturation (double bond —C≡C—). In addition, the removal of sulphur requires one hydrogen molecule for each “bridging” sulphur atom between two hydrocarbon macromolecules or between two parts of the same macromolecule. Sometimes, the possible unsaturation is in turn saturated by an additional hydrogen molecule:

[—CH₂—]11*[—CH₂-]M*+H₂=[—CH₂-]n[—CH₂-]m
with additional loss of hydrogen and a significant impact on costs and the environment (where hydrogen does not have a green origin).

The need is therefore felt to have a process for the treatment of plastic polymeric material deriving from tyre waste which is economically convenient and at the same time allows to minimize unwanted products as well as to convert this polymeric material into commercial products of high value, favouring the circular economy and without any expense in terms of hydrogen consumption.

Examples of known processes related to devulcanization processes are described in documents US 2006116431 A1 and US 2020181372 A1. Specifically, document US4200611631 envisages the addition, after grinding and prior to the devulcanization step, of a swelling solvent and a precursor of the devulcanization catalyst of the rubber.

With respect to US372, this describes a further process for the devulcanization of thermosetting rubber obtained by mixing pulverized rubber and a thermoplastic polymer, a main chain backbone protecting antidegradant (in other words, sterically hindered phenols, quinones, alkylphenylamines, dialkylphenylenediamines, alkylarylphenylenediamines, and polymerized trimethylquinoline, which prevent further degradation of the polymers), a green strength enhancer, and a devulcanization promoter, i.e., an oxide of a metal supported on an inorganic material together with endcapping reagents.

### SUMMARY OF THE INVENTION

In order to overcome the aforesaid problems, a process and a related system have been designed that allow the chemical recovery of tyres, allowing their high-efficiency conversion into high value-added chemicals in addition to reducing the waste produced and maintaining a high degree of safety.

The object of the present invention is therefore a process for the chemical treatment of scrap tyres, comprising the steps of:
a) grinding the tyres and removing the inorganic material;
b) melting the material from step a) at temperatures above 200° C., preferably above 250° C.;
c) devulcanizing the molten material from step b) according to the reaction R1

R1:[—CH₂—]n-S—[—CH₂]m+H₂=[—CH₂—]n*[—CH₂—]m*H₂S

where m and n indicate non-identical lengths of the macromolecules in terms of carbon atoms and the asterisk indicates the possible presence of at least one olefin unsaturation, at a temperature comprised between 300 and 400° C., at a pressure comprised between 10 and 150 bar,
said reaction R1 being possibly carried out in the presence of the saturation reaction R2 of said possible at least one olefin unsaturation:

R2:[—CH₂—]n*+[—CH₂—]m*+H₂=[—CH₂—]n+[—CH₂]m
d) converting the plastics from step c) into products of commercial value selected from:

This process is characterized in that:

step (c)
is carried out in the presence of catalysts based on cobalt oxide or molybdenum oxide possibly supported on alumina;
and comprises a hydrogen sulphide thermal, catalytic or electrochemical splitting step to obtain hydrogen and sulphur according to the reaction R3:

R3:H₂S═H₂+1/X Sx
and the formed hydrogen is recycled to step c);

The products of commercial value obtained in step d) are selected from:
linear or branched light or higher boiling saturated or unsaturated, paraffinic or naphthenic/aromatic hydrocarbons (pyrolysis processes);
Syngas with different S ratios (H₂ over CO and CO₂) in the simultaneous presence of light hydrocarbons and olefines;
chemicals with high added value such as: methanol, dimethyl ether, acetic acid which can be suitably combined with chemical synthesis processes (mainly in gasification) and/or reforming processes (mainly in pyrolysis processes).

### LIST OF FIGURES

FIG. 1: block diagram of the process and the relative units of a plant in which such a process is achievable according to a first embodiment of the present invention;

FIG. 2: block diagram of the process and the relative units of a plant in which such a process is achievable according to a second embodiment of the present invention;

FIG. 3: block diagram of the process and the relative units of a plant in which such a process is achievable according to a third embodiment of the present invention;

FIG. 4: block diagram of the process and the relative units of a plant in which such a process is achievable according to a fourth embodiment of the present invention;

FIG. 5: block diagram of the process and the relative units of a plant in which such a process is achievable according to a fifth embodiment of the present invention;

FIG. 6: block diagram of the process and the relative units of a plant in which such a process is achievable according to a sixth embodiment of the present invention;

FIG. 7: block diagram of an embodiment of the oven, in which the thermal splitting of hydrogen sulphide of the process according to the present invention occurs;

FIG. 8: block diagram of a second embodiment of the oven for conducting the thermal splitting reaction of hydrogen sulphide of the process according to the present invention;

FIG. 9: block diagram of the thermal splitting step of hydrogen sulphide of the process according to the present invention;

FIG. 10: block diagram of an embodiment of an oven in which the catalytic splitting of hydrogen occurs;

FIG. 11: block diagram of the step of the catalytic splitting process according to the present invention;

FIG. 12: block diagram of an embodiment of a plant in which step d) of the process of the invention is conducted, and in which said step d) comprises a gasification of the devulcanized polymer, hydrogenation of said polymer, steam reforming or reforming of methane, all self-sustained by the combustion of the desulphurized polymer;

FIG. 13: representation of a second embodiment of a plant in which step d) of the process of the invention is conducted, according to the operating methods shown for FIG. 12;

FIG. 14: block diagram of a third embodiment of a plant in which step d) of the process of the invention is conducted, according to the operating methods shown in the description of FIG. 12;

FIG. 15: block diagram of a fourth embodiment of a plant in which step d) of the process of the invention is conducted, according to the operating methods shown in the description of FIG. 12;

FIG. 16: block diagram of a plant for the achievement of a process step in accordance with a fifth embodiment of the present invention;

FIG. 17: block diagram of a plant for the achievement of a process step in accordance with a fifth embodiment of the present invention.

### DETAILED DESCRIPTION

For the purposes of the present invention, the definition “process comprising” does not exclude the presence of additional steps beyond the step expressly mentioned after such a definition.

The definition “Process constituted” and “consisting of” excludes the presence of further steps in addition to those expressly mentioned.

With the process of the invention it is thus possible to obtain products of value, intended as:
linear or branched light or higher boiling saturated or unsaturated, paraffinic or naphthenic/aromatic hydrocarbons (pyrolysis processes);
Syngas with different S ratios (H2 over CO and CO2) in the simultaneous presence of light hydrocarbons and olefins;
chemicals with high added value such as: methanol, dimethyl ether, acetic acid if appropriately combined with chemical synthesis processes (mainly for gasification) and/or reforming (mainly for pyrolysis processes).

The process according to the present invention makes it possible to remove the sulphur from vulcanized plastics, whether they come from tyres or not, to prepare the desulphurized waste plastics for chemical recovery treatments and to use the hydrogen obtained by thermally splitting the hydrogen sulphide formed in the desulphurization reaction

The process in accordance with the present invention also allows an energy recovery to self-sustain the initial pre-treatment steps of the vulcanized plastic (melting and dehalogenation).

For the purposes of the present invention, scrap tyres can fall within the definition of a plasmix with a relevant sulphur content. An example of the chemical composition of the tyres is shown in the table below.

| Component | % weight |
|---|---|
| Rubber (natural or synthetic) | 41 |
| Additives (carbon black, chalk . . .) | 30 |
| Reinforcing fibres (nylon, rayon, metal) | 15 |
| Plasticizers (oils, resins) | 6 |
| Vulcanizers (sulphur, zinc oxide) | 6 |
| Anti-ageing | 2 |

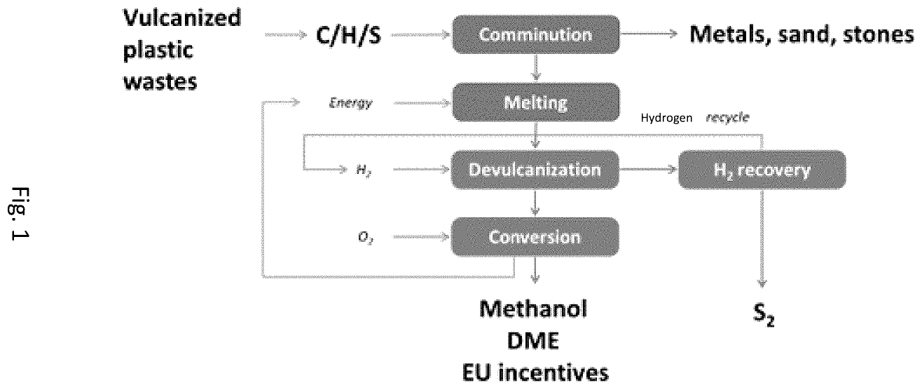

In other words, the tyres are representable at the elementary level as a mixture of carbon, hydrogen and sulphur (C/H/S as indicated in FIGS. 1-6).

The process comprises a first step a) of tyre grinding, referred to as COMMINATION in FIGS. 1-6. The vulcanized plastic of the tyres is ground by systems known to those skilled in the art. In this step a) the inorganic material present in the plastic which could cause disturbances in the subsequent process steps is also removed. Among the inorganic materials, for example, there can be residues of sand, glass, metals, stones, etc.

The process comprises a subsequent step b) of melting the material coming from step a) specifically the vulcanized plastic ground and cleaned of inorganic residues, indicated with MELTING in the figures. The plastic from step a) is supplied to a melter capable of melting it at temperatures above 200° C., preferably above 250° C.

The process comprises a subsequent step c) of devulcanizing the molten material from step b). Such devulcanization takes place according to the reaction R1:

R1:[—CH₂—]n-S—[—CH₂—]m+H₂=[—CH₂—]n*[—CH₂—]m*+H₂S

where m and n indicate non-identical lengths of the macromolecules in terms of carbon atoms and the asterisk indicates the possible presence of at least one olefin unsaturation. Possibly the R1 reaction is associated with the saturation reaction R2 of the at least one olefin unsaturation:

R2:[—CH₂—]n*+[—CH₂—]m*+H₂=[—CH₂—]n+[—CH₂]m

Preferably, in step c) the slurry reagent comprising plastics and added with catalyst is reacted with hydrogen.

The catalyst used shall withstand poisoning by sulphur and sulphurized organic compounds and shall withstand the presence of light and heavy, paraffinic, naphthenic or aromatic hydrocarbons.

The catalysts used in step c) are selected from cobalt oxide or molybdenum oxide possibly supported on alumina.

According to a preferred embodiment, step c) is conducted at a temperature comprised between 300 and 350° C., between 50 and 100 bar. The above temperature range was chosen to promote the activation of the catalysts while avoiding significant degradation of the polymer chains (and to prevent the formation of high concentrations of hydrocarbons together with the leakage of H₂S). On the other hand, regarding the pressure ranges, these favour hydrogenation as a function of the increase in pressure itself.

Step c) is carried out in a homogeneous or heterogeneous fixed or mobile bed reactor (fluidized or dragged).

Thus, in the devulcanization of step c) H₂S is produced which, according to the present invention, is transformed into sulphur and hydrogen and the latter is recycled to the same devulcanization step c).

This step is also called splitting, which follows the reaction pattern R3

R3:H₂S═H₂+1/xSₓ

shown in FIGS. 1-6, with H₂ RECOVERY or SACS or SATS.

The products thus obtained can be reused. Specifically, the formed hydrogen is recycled to step c). Instead, the sulphur obtained can be treated and used in other plants (e.g., new vulcanizations, sulphuric acid production).

According to a preferred embodiment, the elemental sulphur can be separated from the hydrogen by condensation.

In the case where the unreacted H₂S is present from the splitting reaction, this can be separated by softening processes and the hydrogen is recycled to step c).

Furthermore, the unreacted H₂S can also be recycled internally to the hydrogen recovery unit for complete recovery. In case of small quantities of H₂S present in the hydrogen stream leaving the splitting step, it is possible to recycle the same stream at step c). It should be noted that low percentages of input H₂S do not significantly affect yields or related operations.

Therefore, after adequate initial feeding of hydrogen to step c), for example by the use of cylinders, the invention is thus able to self-sustain, solving one of the main problems of chemical devulcanization, namely the consumption of large amounts of hydrogen.

According to a preferred embodiment, the splitting reaction R3 is thermal or can be catalysed. It should be noted that the splitting reaction R3 can also be carried out by electrochemical means.

Specifically, the present invention has several methods of implementation as shown in the figures, in which the step of splitting and relative recovery of hydrogen is carried out by the following means of technology:
SATS (Sulphidric Acid Thermal Splitting) capable of performing reaction R3 by thermal means and of separating the hydrogen to be recycled from elemental sulphur and any unreacted H₂S. This technology is the subject of international patent application number WO2020/234708 A1;
SACS (Sulfidric Acid Catalytic Splitting) capable of performing reaction R3 catalytically and separating the hydrogen to be recycled from elemental sulphur and any unreacted H₂S. This technology is the subject of international patent application number WO 2020/234709 A1.

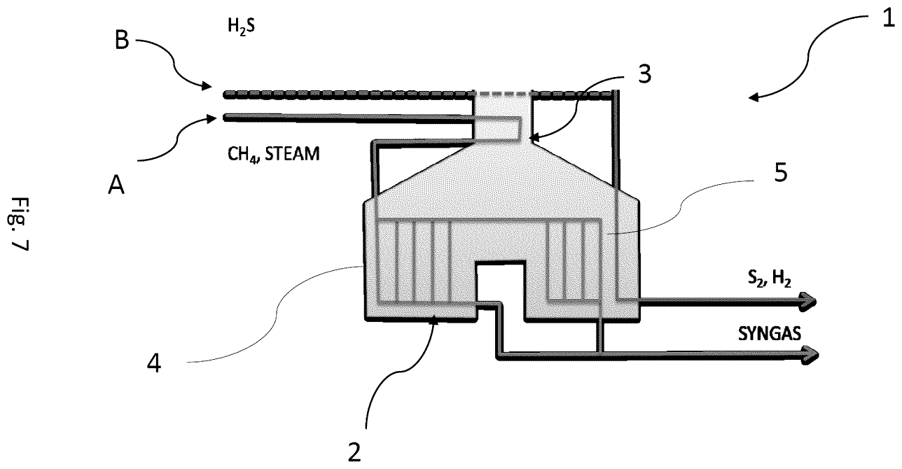

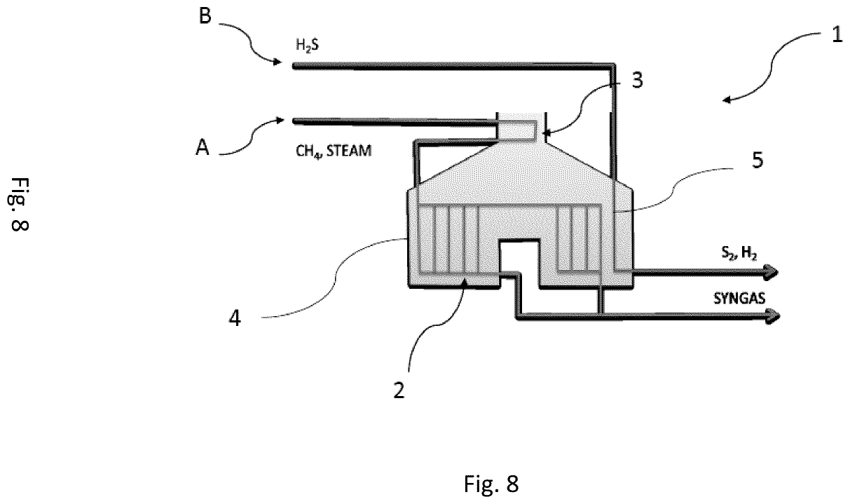

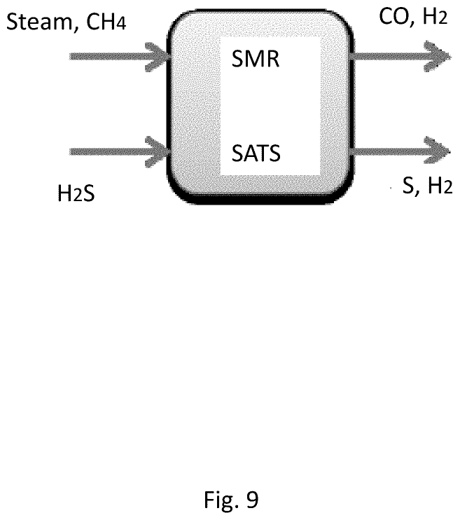

In the case where the splitting reaction R3 is of the thermal SATS type (FIGS. 7, 8 and 9), this is carried out in an oven 1 comprising a radiant zone 2 and a convective zone 3. The oven further comprises a first 4 and a second 5 set of tubes in which at least two segregated process flows of gas A and B pass respectively. It should be noted that the first set of tubes 4 is provided with a catalyst while the second set of tubes 5 is made of material resistant to acidic gases.

The oven 1 is arranged so that the first process flow A enters the oven 1 from the convective zone 3 and passing through the first set of tubes 4 exits the oven from the radiant zone 2. Alternatively, the first process flow A enters the oven 1 from the radiant zone 2 and, passing through the first set of tubes 4, exits the radiant zone 2. Instead, the second process flow B enters the oven 1 from the convective zone 3 or the radiant zone 2 and, passing through the second set of tubes 5, exits from said oven 1 from the radiant zone 3. In detail, the second flow B entering the oven comprises hydrogen sulphide passing through said second set of tubes 5, where the reaction R3 (SATS) occurs at the radiant zone 2, while the flow A comprising methane and water, passes through said first set of tubes 4, said first set of tubes comprising a tube bundle filled with catalyst and arranged at the radiant zone 2, where the reaction R4 (SMR: Steam Methane Reformer) is carried out.

R4:CH₄+H₂O=CO+3H₂

Preferably, the reaction R3 is in the ranges of preferred temperatures and pressures contemplated in the aforesaid WO2020/234708 A1.

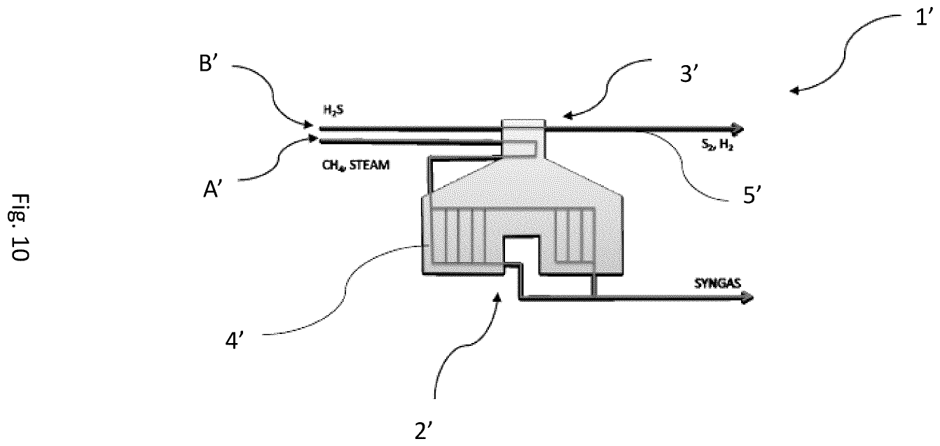

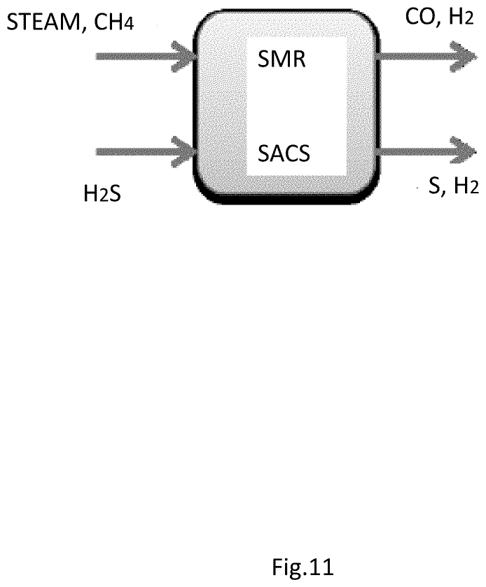

In the case in which the splitting reaction R3 is of catalytic SACS type (FIGS. 10 and 11) this is carried out in an oven comprising a radiant zone 2′ and a convective zone 3′. The oven further comprises a first 4′ and a second 5′ set of tubes, in which two segregated gas process flows A′ and B′ respectively pass. Specifically, the second set of tubes 5′ is made of acid gas-resistant material and is provided with a catalyst.

The oven 1′ is arranged so that the first process flow A′ enters the oven 1′ from the convective zone 3′ and, passing through the first set of tubes 4′, exits said oven from the radiant zone 2′. Alternatively, the first process flow A′ enters the oven 1′ from the radiant zone 2′ and, passing through the first set of tubes 4′, exits the oven from the radiant zone 2′. Instead, the process flow B′, enters said oven 1′ from the convective zone 3′ passing through said second set of tubes 5′ and exits from the oven 1′ from the convective zone 3′. It should be noted that the second flow B′ comprising H₂S passes into the second set of tubes 5′, where, at the convective zone 3′, the reaction R3 (SACS) is carried out. Instead, the flow A′ comprising methane and water, passes through the first set of tubes 4′, comprising a tube bundle filled with catalyst and arranged near the radiant zone 2′. In the first set of tubes 4′, the reaction R4 (SMR) is carried out

R4:CH₄+H₂O=CO+3H₂

Preferably, the reaction R3 is carried out in the preferred pressure and temperature ranges contemplated in WO 2020/234709 A1.

For the purposes of the present invention, it should be noted that the oven 1, 1′ comprises an upper convective zone, 3′ where the heat exchange takes place by convection. The lower part, defined radiant zone, 2′, comprises a firebox with one or more vertical and/or horizontal burners, configured to radiate the sets of tubes. The convective zone in which the process flow enters the oven is heated by convection through the exhaust gases produced in the radiant zone by combustion of combustible gases. Thereby, the inlet gas process flow undergoes a preheating step.

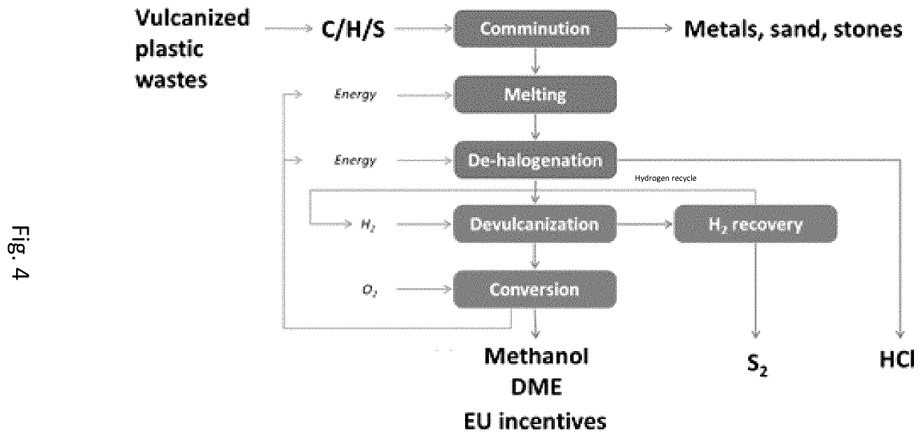

According to a preferred embodiment, if there is a marked presence (a few percent) of PVC contained in the tyre compounds or in the devulcanizing plastic material, the process can comprise a de-halogenation step b′), indicated in the figures with DE-HALOGENATION (FIGS. 4, 5, and 6). Such a step b′) inserted in the process after the melting step b) and before the devulcanization step c) allows to manage plastics with high PVC content. Preferably, step b′) is a dechlorination step with the formation of hydrochloric acid according to the reaction R5

R5:2HCl=H₂+Cl₂

Such a step is carried out if it is desired to chemically convert the tyre rubber with the conventional-type waste plastic (plasmix).

In accordance with a preferred embodiment, step b′) is preferably of a homogeneous non-catalytic type.

Preferably, said step b′) is carried out at a temperature comprised between 300 and 350° C. at residence times greater than 3 minutes, preferably comprised between 5 and 10 minutes. Thereby, using a temperature range similar to that of step c), the marked thermal degradation of the plastic macromolecules is avoided while allowing the HCl to escape as a gas from the liquid phase without excessive dragging of hydrocarbons.

More preferably, the pressure at step b′) can be significantly lower than the pressure expected for devulcanization step c) and is at 1 bar or a little higher or at a pressure of a few bar. For these reasons, downstream of the de-halogenator in which step b′) occurs, it is therefore necessary to provide a pumping system for melted and de-halogenated plastics to bring the fluid to the operating pressures of the devulcanizer (10-150 bar) in which step c) occurs. The operating temperatures of step b′) as well as of the previous and subsequent steps make the molten plastics very fluid and not very viscous, allowing to significantly save the operating costs of pumping. It should be noted that temperatures closer to 350° C. are preferable.

During step b′) no marked sulphur and sulphurized compound release phenomena occur due to the absence of a specific catalyst as well as hydrogen. There are also no marked thermal degradations of the polymer chains. The release of gaseous HCl occurs according to the following reaction:

[—CH₂—CHCl-]n=[—CH═CH-]n+HCl

The recovery of HCl in a single unit allows to use precious materials limited to such a unit in the construction of the equipment, with significant savings. The HCl removed from the plastics and separated by phase is then purified to the quality required by the market. Although with modest market value, it represents an additional process product.

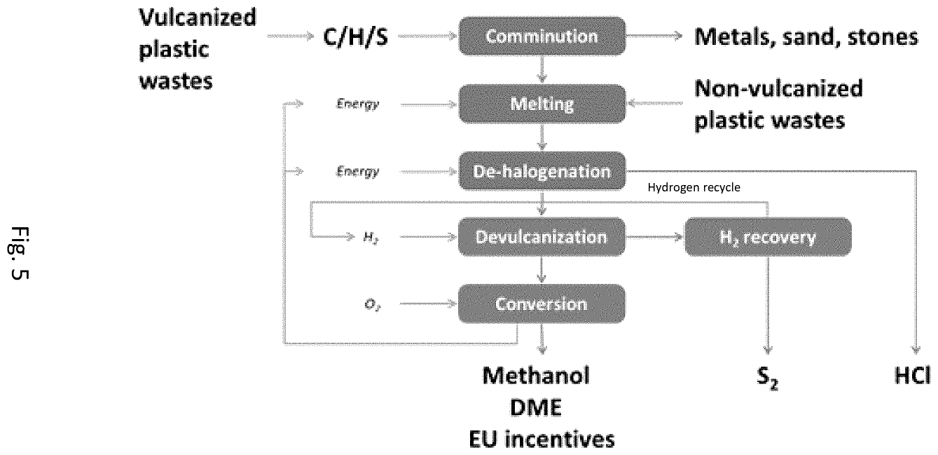

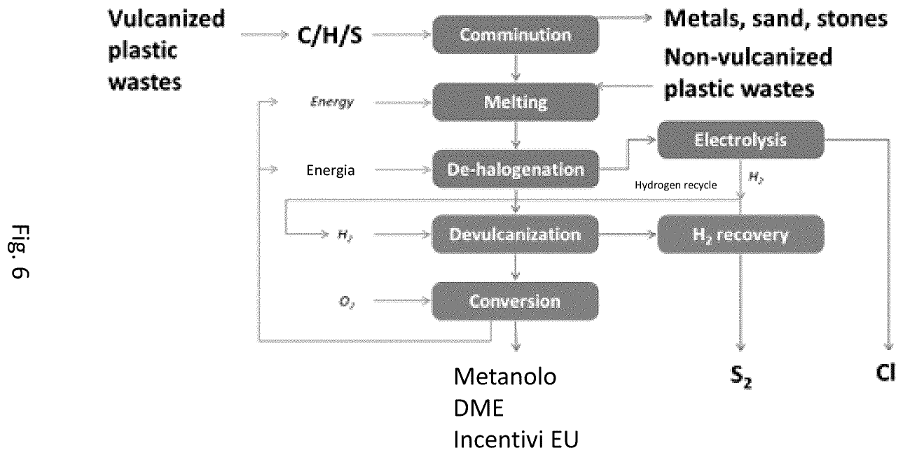

It should be noted that de-halogenation step b′) becomes necessary where it is desired to chemically convert the tyre plastic together with the classic plasmix (FIGS. 5 and 6), which contains 2-4% Polyvinylchloride (PVC). Therefore, in this case plasmix is supplied to the melter, in step b) of melting. Specifically, the unvulcanized plastic can be supplied to the melter, together with the vulcanized plastic, and passed in series from the de-halogenator for the removal of hydrochloric acid, and subsequently into the devulcanizer, in other words passing through steps b′) and c).

According to an alternative embodiment, step b′) and c) with the related de-halogenators and devulcanizers can be envisaged on parallel lines and flow downstream thereof in a single premixed flow before conversion step d) described in detail below. In the case where the mixture of unvulcanized plastics does not have halogens in significant quantities, it is possible to supply the flow just upstream of the unit where conversion step d) occurs, after melting in an additional melter. Such a solution allows to reduce the volumes involved in step c) as well as in the devulcanization unit.

According to a preferred embodiment, the HCl, preferably extracted at step b′) is subjected to electrolysis to obtain hydrogen which is added in step c) and Cl₂ (FIG. 6). Specifically, an electrified integration for hydrolysis of HCl is envisaged. Thereby, it is possible to further increase the market value of the products as well as to increase the availability/production of hydrogen. It should be noted that the hydrolysis of HCl occurs with lower energy expenditure than the electrolysis of water according to the reaction:

2HCl═H₂±Cl₂

The electrolysis unit is known to be particularly energetic, although to a lesser extent for chlorine with respect to water, but the usually small amount of HCl with respect to the process flow rates allow an easy energy integration with renewable systems (e.g., photovoltaic and wind). Thereby, the process allows to obtain good yields of the products at low costs.

As anticipated, the process according to the present invention comprises a step d) of converting plastics from step c) into products of commercial value. The chemical conversion carried out in step d) involves receiving the molten plastic flow cleaned from the sulphur fraction and suitably freed from the devulcanization catalyst. Such a molten mixture is further heated to temperatures greater than 350° C., preferably to temperatures greater than 400° C. and, more preferably, especially to reduce residence times and operating volumes, to temperatures greater than 450° C. According to alternative embodiments, the temperatures used can be greater than 450° C. in the case of oxygen gasification (oxy-gasification) or gasification systems, for which an oxygen stream is included, or a mixture of oxygen (e.g., air or enriched air) or oxygenated molecules (e.g., CO₂, steam).

The products exiting step d) and the relevant conversion unit comprise products of commercial value such as:
linear or branched light or higher boiling saturated or unsaturated, paraffinic or naphthenic/aromatic hydrocarbons (pyrolysis processes);
Syngas with different S ratios (H₂ over CO and CO₂) in the simultaneous presence of light hydrocarbons and olefines;
chemicals with high added value such as: methanol, dimethyl ether, acetic acid if appropriately combined with chemical synthesis processes (mainly for gasification) and/or reforming (mainly for pyrolysis processes).

Furthermore, it should be noted that, depending on the output temperatures of the products, the hot stream can be used as an energy integration in the previous steps of melting, de-halogenation and in some cases also for devulcanization. Specifically, the energy integration occurs in the steps where heating is required.

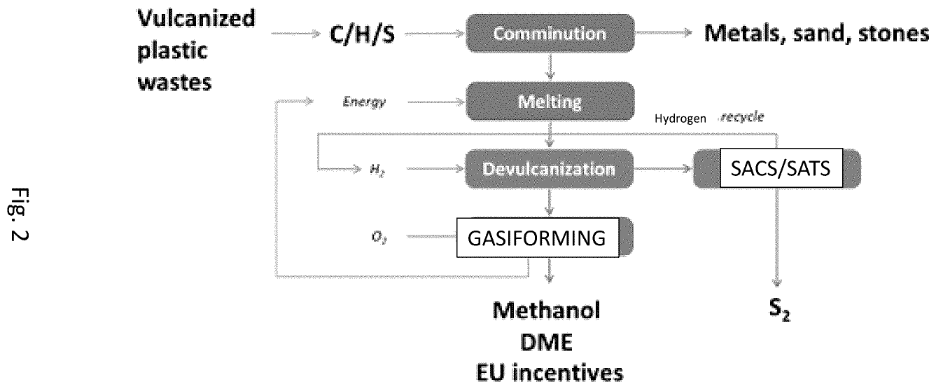

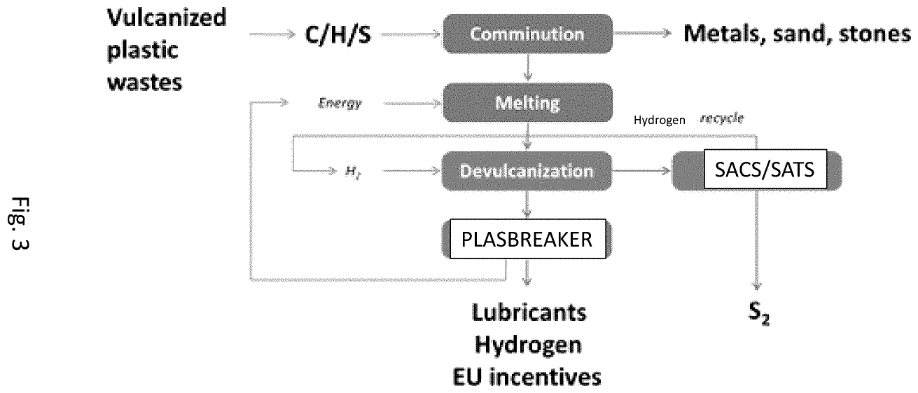

The conversion step can be performed in accordance with different operating modes which can be combined with the aforesaid SATS and SACS operating modes. Specifically, step d) can be accomplished by:
gasification, indicated in FIG. 2 as GASIFORMING. In other words, the conversion system characterized by a gasification associated with hydrogenation and reforming is able to convert the mixtures of plastic waste into syngas and, therefore, into hydrogen or methanol or dimethyl ether. Such a technology is the subject of international patent application WO2021/019433 A1;
pyrolysis, referred to in FIG. 3 as PLASBREAKER, in other words, a process in which the final step is a liquid phase pyrolysis capable of converting plastics into (partially) hydrofinished lubricant bases and hydrogen. Such technology is the subject of Italian patent application No. 102020 000019951.

It should be noted that while gasification requires oxygen, pyrolysis is carried out without an initial supply of oxygen. A further difference between the two types of conversion is the outlet temperature of the products. Specifically, in the case of pyrolysis, the temperatures of 400-500° C., but also up to 700° C. for gas phase pyrolysis systems, allow an energy recovery in melting step b) using the thermal energy of the effluents to melt the plastic. Regarding the case of gasification, the temperatures of the products being in a wider temperature range (750-1100° C.) allow a greater energy recovery by passing the flow of hot products, for example, to the splitting unit and then to the unit where the melting occurs or directly to the unit where the melting occurs. Furthermore, in the case of the gasification being the product flow with greater enthalpy, this can also be used for the de-halogenation unit as well as for the previous units.

According to a preferred embodiment illustrated in FIG. 2, the conversion step is carried out according to the following steps, especially when the commercial product to be obtained is syngas possibly associated with higher hydrocarbons:
A) gasification of the pretreated polymers according to the following reaction scheme R6:

R6:[—CH₂—]+H₂O=CO+2H₂
B) hydrogenation of said polymers pretreated with higher hydrocarbons and methane with the hydrogen produced in R6, according to the following reaction scheme R7:

R7:[—CH₂—]n+H₂=CnH(2n+2);
wherein n is an integer from 1 to 3, said reaction R7 possibly being combined with oligomer and olefin formation reactions;
C) methane steam reforming according to the reaction R4:

R4: CH₄+H₂O=CO+3H₂
and possibly:
D) the methane reforming reaction according to the following reaction scheme R8:

R8:CH₄+CO₂=2CO+2H₂

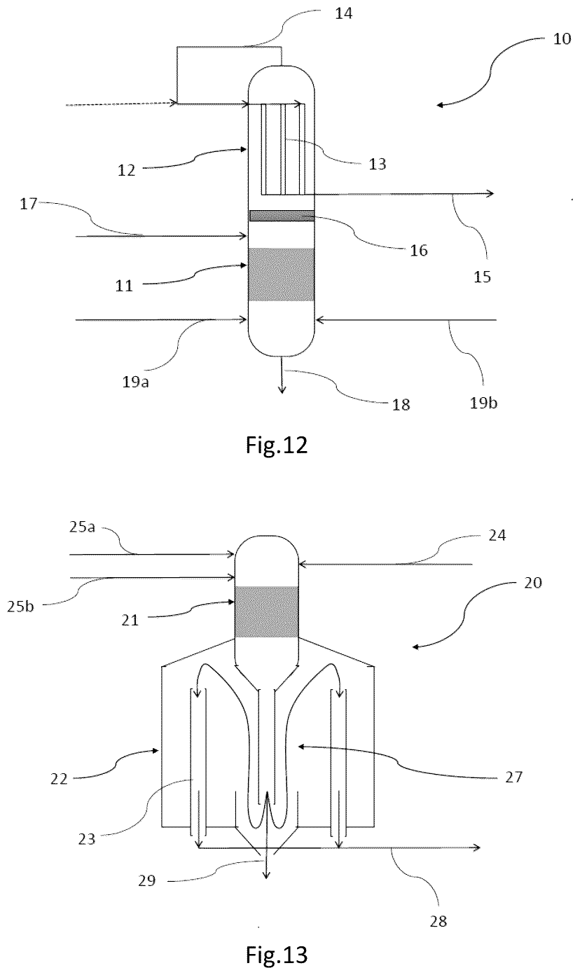

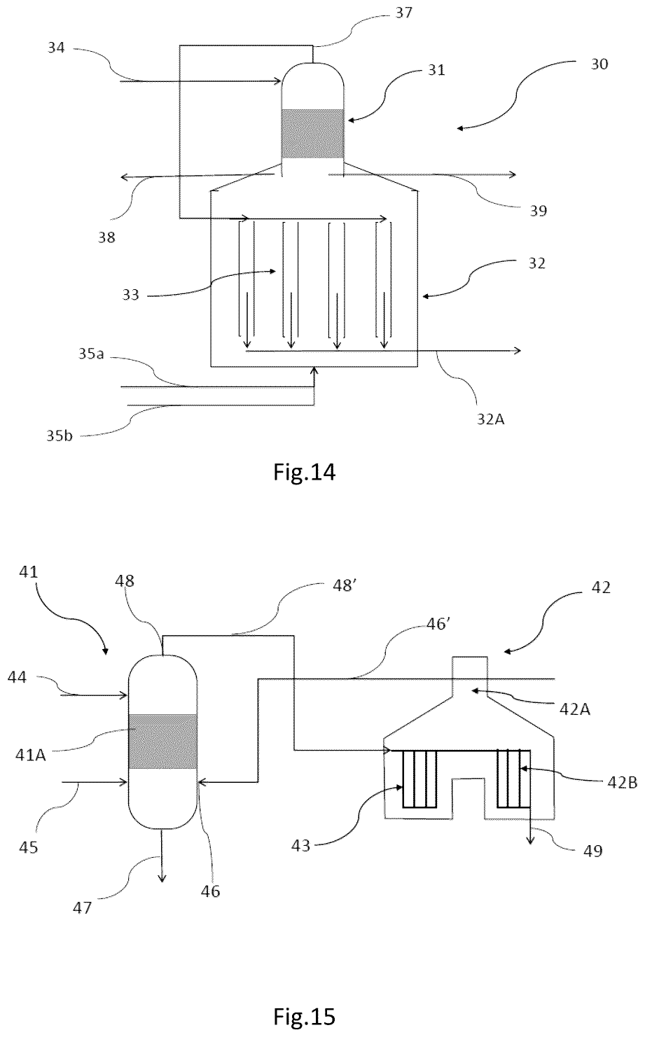

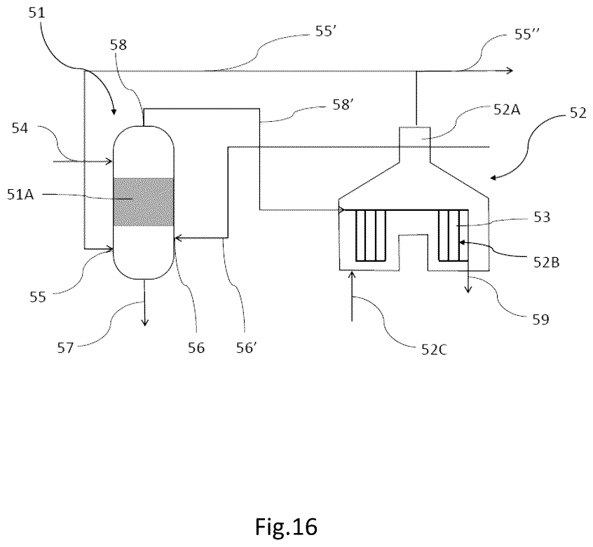

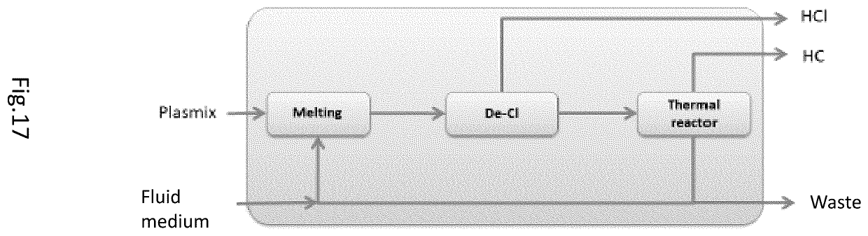

Specifically, such steps are carried out in a plant 10, 20, 30, 40, 50 illustrated in FIGS. 12-16. Such a plant as well as the related steps carried out therein are described in detail in the international patent application related to GASIFORMING, reported above, and for this reason are not described in detail below. The plant 10, 20, 30, 40, 50 comprises a gasification section 11, 21, 31, 41, 51 and a reforming section 12, 22, 32, 42, 52 comprising a tube bundle 13, 23, 33, 43, 53 provided with a catalyst. Specifically:
i) the gasification section 11, 21, 31, and reforming section 12, 22, 32, are part of a single reactive unit 10, 20, 30, or the gasification section 41, 51 and the reforming section 42, 52 are two mutually physically distinct reactive units 40, 50.
ii) the gasification section 11, 21 or the reactive unit 41, provides the energy support to the respective reforming section 12, 22, or reactive unit 42, by virtue of the exothermic combustion reaction R9

R9:[—CH₂—]+1,5O₂=CO₂+H₂O
or alternatively:
the section 32, the reactive reforming unit 52, provides the energy support to the respective section 31 or reactive gasification unit 51 by virtue of the exothermic reaction R10:

R10:CH₄+2O₂═CO₂+2H₂O

When in the process according to the present invention in step d) it is desired to obtain a chemical with high added value, syngas is used as the starting material which is converted into methanol according to the following reaction R11:

R11:2H₂+CO→CH₃OH

Subsequently if dimethyl ether is to be obtained, the methanol is converted to dimethyl ether according to the reaction R12

R12:2CH₃OH→CH₃OCH₃+H₂O

Dimethyl ether can also be obtained by direct synthesis from syngas and not only from methanol dehydration.

If acetic acid is to be obtained, it is obtained according to the reaction R13:

R13:CH₃OH+CO→CH₃COOH

In accordance with a preferred embodiment, illustrated in FIG. 3, in which step d) is conducted, the conversion system is characterized by PLASBREAKER pyrolysis. In this case step d) is carried out in the absence of oxygen at a temperature between 410° C. and 500° C. and with residence times>5 minutes and ≤20 minutes, in which the reaction products comprise mainly low boiling hydrocarbons, and to a lesser extent hydrogen, naphtha, gasoline, jet fuel, gas oils, heavy oils, residues. It should be noted that the conversion step d) corresponds to step c) described in the relevant Italian patent application and carried out in the THERMAL REACTOR illustrated in FIG. 17 of the present patent application.

Preferably, the reactor where step d) is conducted in accordance with the present embodiment is a tubular reactor provided with multiple multi-step tubes.

It is a further object of the present invention a system configured for carrying out the process described above. As mentioned during the description, each step of the process is carried out in a relative unit provided with structural features able to withstand the temperatures of the steps and the relative release of the products of the different reactions. Each unit is in fluid communication with the unit at which the next step of the process occurs. In detail, the plant comprises:
a grinding unit COMMINATION where step a) occurs,
a melting unit or melter unit MELTING where step b) occurs. Such a unit is configured to receive the ground material and possibly plasmix in input;
a possible dehalogenation unit DE-HALOGENATION where step b′) occurs in fluid communication with the MELTING unit;
an electrolysis unit ELECTROLYSIS, possibly present in the case where the dehalogenation unit DE-HALOGENATION is present. Such an electrolysis unit ELECTROLYSIS is in fluid communication with the dehalogenation unit DE-HALOGENATION;
a devulcanization unit DEVULCANIZATION in fluid communication with the melting unit MELTING or if present with the dehalogenation unit DE-HALOGENATION;
an splitting unit H2 RECOVERY, SATS, SACS in fluid communication with the dehalogenation unit DE-HALOGENATION to receive H₂S and then send H₂ to the dehalogenation unit DEVULCANIZATION. It should be noted that if the electrolysis unit is present, ELECTROLYSIS is in fluid communication with the dehalogenation unit DEVULCANIZATION to send H₂ produced together with that of the splitting unit H2 RECOVERY, SATS, SACS;
a conversion unit CONVERSION, PLASBREAKER or GASFORMING, in fluid communication with the dehalogenation unit DE-HALOGENATION to receive the molten plastic. Such conversion unit CONVERSION, PLASBREAKER, or GASFORMING can feature a tube bundle and related heat exchangers in order to harness the thermal energy of the conversion products for the melting, de-halogenation and/or splitting unit.

1. Process for chemically treating scrap tyres, comprising:
a) grinding the tyres and removing the inorganic material;
b) melting the material from step a);
c) devulcanizing the molten material from step b) according to the reaction R1
R1:[—CH₂—]n-S—[—CH₂—]m+H₂=[—CH₂-]n*+[—CH₂-]m*+H₂S
where m and n indicate non-identical lengths of the macromolecules in terms of carbon atoms and the asterisk indicates the possible presence of at least one olefin unsaturation, at a temperature comprised between 300 and 400° C., at a pressure comprised between 10 and 150 bar, said reaction R1 being possibly associated with the saturation reaction R2 of said possible at least one olefin unsaturation:
R2:[—CH₂-]n*+[—CH₂—]m*+H₂=[—CH₂—]n+[—CH₂—]m
d) converting the plastics from step c) into products of commercial value wherein
step c):
is carried out in the presence of catalysts based on cobalt oxide or molybdenum oxide possibly supported on alumina;
said step c) further comprises, as step c-1), a hydrogen sulphide thermal, catalytic or electrochemical splitting step to obtain hydrogen and sulphur according to the reaction R3:
R3:H₂S═H₂+1/xSx
and the formed hydrogen is recycled to step c),
the commercial products obtained in step d) are selected from:
linear or branched light and higher boiling saturated or unsaturated: hydrocarbons, paraffinic or naphthenic/aromatic hydrocarbons;
syngas having different S ratio H2/CO or H2/CO2 in the contemporaneous presence of light hydrocarbons or olefines
highly added values chemicals selected from methanol, dimethyl ether and acetic acid-.

2. Process according to claim 1, wherein step c) is carried out at a temperature between 300 and 350° C. at a pressure between 10 and 150 bar.

3. Process according to claim 1, wherein step c) is carried out in a homogeneous or heterogeneous fixed or mobile bed reactor (fluidized or dragged).

4. Process according to claim 3, wherein, when the splitting reaction of step c-1) is of the thermal type it is carried out in an oven comprising:
a radiant zone (2), and a convective zone (3),
a first (4) and a second (5) series of tubes in which at least two segregated process flows of gas (A) and (B) pass respectively, of which the first series of tubes (4) is provided with a catalyst while the second series of tubes (5) is made of material resistant to acidic gases wherein;
the first process flow (A) enters said oven (1) from the convective zone (3) and passing through said first set of tubes (4) exits from said oven from the radiant zone (2), or alternatively said first process flow (A) enters said oven (1) from the radiant zone (2) and, passing through the first set of tubes (4), exits from the radiant zone (2);
the second process flow (B) enters said oven (1) from the convective zone (3) or the radiant zone (2) and, passing through said second series of tubes (5), exits from said oven (1) from the radiant zone (3),
and wherein the flow (B) entering said oven comprises hydrogen sulphide passing through said second series of tubes (5), where the reaction R3 (SATS) occurs at the radiant zone (2), while the flow (A) comprising methane and water, passes through said first series of tubes (4), said first series of tubes comprising a tube bundle filled with catalyst and arranged at the radiant zone (2), where the reaction R4 (SMR) is carried out
R4:CH₄+H₂O=CO+3H₂

5. Process according to claim 3, wherein when the splitting reaction is of the catalytic type, it is carried out in an oven (1′) comprising:
a radiant zone (2′),
a convective zone (3′),
a first (4′) and a second set of tubes (5′), in which two segregated process flows of gas (A′) and (B′) pass respectively, of which the second set of tubes (5′) is made of material resistant to acidic gases and is provided with a catalyst,
in which oven:
said first process flow (A′) enters said oven (1′) from the convective zone (3′) and, passing through said first series of tubes (4′), exits from said oven from the radiant zone (2′), or alternatively said first process flow (A′) enters said oven (1′) from the radiant zone (2′) and, passing through the first series of tubes (4), exits from said oven from the radiant zone (2′);
said process flow (B′), enters said oven (1′) from the convective zone (3′) passing through said second set of tubes (5′) and exits from said oven (1′) from the convective zone (3′),
and wherein:
the second flow (B′) comprising H₂S passes in the second series of tubes (5′), where, at the convective zone (3′), the reaction R3 (SACS) is carried out; while the flow (A′) comprising methane and water, passes through said first series of tubes (4′), said first series of tubes comprising a tube bundle filled with catalyst and arranged at the radiant zone (2′), where the reaction R4 (SMR) is carried out
R4:CH₄+H₂O=CO+3H₂

6. Process according to claim 1, comprising after the melting step b) and before the devulcanizing step c) a dechlorinating step b′, with hydrochloric acid formation according to the reaction R5
R5:2HCl=H₂+Cl₂
if it is desired to chemically convert the tyre rubber with the conventional-type waste plastic (plasmix).

7. Process according to claim 6, wherein said dechlorinating step b′) is carried out at a temperature between 300 and 350° C. at residence times higher than 3 minutes.

8. Process according to claim 6, wherein the plasmix is supplied to the melter, in step b) of melting.

9. Process according to claim 6, wherein HCl is electrolysed to obtain hydrogen which is added in step c) and Cl₂.

10. Process according to claim 1, wherein, when the commercial product to be obtained is syngas possibly associated with higher hydrocarbons, oligomers and olefins, step d) comprises:
A) gasification of the pretreated polymers according to the following reaction scheme R6:
R6:[—CH₂—]+H₂O=CO+2H₂
B) hydrogenation of said polymers pretreated with higher hydrocarbons and methane with the hydrogen produced in R6, according to the following reaction scheme R7:
R7:[—CH₂—]n+H₂=CnH(2n+2);
wherein n is an integer from 1 to 3, said reaction R7 possibly being combined with oligomer and olefin formation reactions;
C) methane steam reforming according to the reaction R4:
R4:CH₄+H₂O=CO+3H₂
and possibly:
D) the methane reforming reaction according to the following reaction scheme R8:
R8:CH₄+CO₂=2CO+2H₂
said process being conducted in a plant (10), (20), (30), (40), (50) comprising a gasification section (11), (21), (31), (41), (51) and a reforming section (12), (22), (32), (42), (52) comprising a tube bundle (13), (23), (33), (43), (53) provided with a catalyst, wherein:
i) said gasification section (11), (21), (31), and reforming section (12), (22), (32), are part of a single reactive unit (10), (20), (30), or said gasification section (41), (51) and said reforming section (42), (52) are two mutually physically distinct reactive units (40), (50).
ii) the gasification section (11), (21) or the reactive unit (41), provides the energy support to the respective reforming section (12), (22), or reactive unit (42), by virtue of the exothermic combustion reaction R9
R9:[—CH₂—]+1,5O₂═CO₂+H₂O
or alternatively:
the section (32), the reactive reforming unit (52), provides the energy support to the respective section (31) or reactive gasification unit (51)
by virtue of the exothermic reaction R10
R10:CH₄+2O₂═CO₂+2H₂O

11. Process according to claim 1, wherein the syngas is converted to methanol according to the following reaction scheme R11:
R11:2H₂+CO→CH₃OH

12. Process according to claim 11, wherein methanol is converted to dimethyl ether according to the reaction scheme R12
R12:2CH₃OH→CH₃OCH₃+H₂O

13. Process according to claim 11, wherein acetic acid is prepared according to the scheme R13:
R13:CH₃OH+CO→CH₃COOH

14. Process according to claim 1, wherein step d) is carried out in the absence of oxygen at a temperature between 410° C. and 500° C. and with residence times>5 minutes and ≤20 minutes, wherein the reaction products comprise mainly low boiling hydrocarbons, and to a lesser extent hydrogen, naphtha, gasoline, jet fuel, gas oils, heavy oils, residues.

15. Process according to claim 14, wherein the reactor where step d) is carried out is a tubular reactor equipped with multiple multipass tubes.

16. Process according to claim 1, wherein the dimethyl ether can also be produced by direct synthesis from syngas.
